(19) United States
(12) Patent Application Publication
(10) Pub. No.: US 2008/0241497 A1
(43) Pub. Date: Oct. 2, 2008

(54) PROCESS FOR PRODUCING POLYIMIDE FILM, AND POLYIMIDE FILM

(75) Inventors: Hiroaki Yamaguchi, Yamaguchi (JP); Shinsuke Yabunaka, Yamaguchi (JP)

Correspondence Address: KNOBBE MARTENS OLSON & BEAR LLP, 2040 MAIN STREET, FOURTEENTH FLOOR, IRVINE, CA, 92614, US

(73) Assignee: UBE INDUSTRIES, LTD., Yamaguchi (JP)

(21) Appl. No.: 12/060,051

(22) Filed: Mar. 31, 2008

(30) Foreign Application Priority Data
Mar. 31, 2007 (JP) 2007-95824

(51) Int. Cl. B32B 7/02; B05D 3/00; B32B 15/08

(52) U.S. Cl. 428/220; 427/372.2; 428/458

(57) ABSTRACT

A solution containing a silane coupling agent, in which 5% or more of the alkoxy group bound to an Si atom is hydrolyzed, and substantially no water, is applied to one side or both sides of a self-supporting film of a polyimide precursor solution, and then the self-supporting film is heated to effect imidization, thereby providing a polyimide film having a thickness of 7 μm to 30 μm with reliably improved adhesiveness.

### CROSS-REFERENCE TO RELATED APPLICATIONS

This application claims the benefit and priority to Japanese Application Number 2007-95824 filed on Mar. 31, 2007, which is hereby incorporated by reference in its entirety.

### BACKGROUND OF THE INVENTION

1. Field of the Invention

The present invention relates to a process for producing a polyimide film with improved adhesiveness. The present invention also relates to a polyimide film and a copper-clad polyimide film.

2. Background Art

A polyimide film is widely used in various applications such as the electric/electronic device field and the semiconductor field, because it has excellent heat resistance, chemical resistance, mechanical strength, electric properties, dimensional stability and so on. For example, a commonly used flexible printed circuit board (FPC) is a copper-clad laminate wherein a copper foil is laminated on one side or both sides of a polyimide film.

However, a polyimide film may not have sufficiently adhesive properties. When a metal foil such as a copper foil is bonded onto a polyimide film with a heat-resistant adhesive such as an epoxy resin adhesive, high adhesive strength may not be achieved. Furthermore, a laminate having high peel strength may not be obtained when a metal layer is formed on a polyimide film by vapor deposition or sputtering.

As a method for improving adhesive property of a polyimide film, Japanese Kokoku Patent Publication No. 1994-002828 (Patent document 1) discloses a process for producing a polyimide film wherein a surface treatment solution containing 0.5 wt % or more of at least one heat-resistant surface treating agent (coupling agent) selected from the group consisting of aminosilane coupling agents and epoxysilane coupling agents, and 20 wt % or less of water is evenly applied to a surface of a self-supporting film (a solidified film) of a polyimide precursor solution; and then the solidified film with the applied surface treatment solution is heated to 100 to 600° C., thereby drying and heat-treating the solidified film, and imidizing a polyamic acid comprising the film. In addition, Japanese Laid-open Patent Publication No. 1988-99281 (Patent document 2) discloses a process for producing a polyimide film wherein a polyamic acid varnish is flow-casted and dried to form a polyamic acid film; and the film is dipped into a solution of a silane coupling agent; and then the film is heated to effect ring closure (imidization).

### LIST OF REFERENCES

Patent document 1: Japanese Kokoku Patent Publication No. 1994-002828;
Patent document 2: Japanese Laid-open Patent Publication No. 1988-99281.

### SUMMARY OF THE INVENTION

Conventionally, a self-supporting film of a polyimide precursor solution is prepared by flow-casting and applying a solution of a polyimide precursor on a support such as a stainless substrate and a stainless belt, and then heating it sufficiently to make it self-supporting, which means a stage before a common curing process; specifically, heating it at 100 to 180° C. for about 2 to 60 min. According to this process, however, when a solution of a coupling agent is applied to both sides of a self-supporting film, adhesiveness may differ between the side of the obtained polyimide film which was in contact with the support when producing the film (side B) and the opposite side which was not in contact with the support (side A).

Meanwhile, with the reduction in size, thickness and weight of electronic devices in recent years, there is the need for the reduction in size of the inner parts. Accordingly, there is the need for a further thinner copper-clad polyimide film, which is used as a flexible printed circuit board (FPC), for example, and therefore, a thinner polyimide film, specifically a polyimide film with a thickness of 20 μm or less, particularly 15 μm or less has come into use. However, the thin polyimide films produced by the above process wherein a solution of a coupling agent is applied to the surface of a self-supporting film of a polyimide precursor solution, and then the self-supporting film is heated to effect imidization, may be of uneven improved adhesiveness. As the effect of improving adhesiveness of a thinner polyimide film may vary relatively widely, a polyimide film with adequately improved adhesiveness is not always obtained by the above process.

Variations in the effect of improving adhesiveness of such a relatively thinner polyimide film, and the difference in adhesiveness between side A and side B of the polyimide film are caused by the following reasons.

A silane coupling agent has an alkoxy group bound to an Si atom, and the alkoxy group reacts with a compound containing an active hydrogen, e.g. water, through a dealcoholization reaction. When modifying the surface properties by applying a solution containing a silane coupling agent to a self-supporting film of a polyimide precursor solution, and then heating it to effect imidization, the surface is modified by the reaction of the coupling agent and water which is generated by the imidization. However, depending on the degree of penetration of the silane coupling agent solution into the self-supporting film, the silane coupling agent may be vaporized without being involved in the reaction, and consequently the desired surface properties and adhesiveness may not be achieved. The degree of penetration of the silane coupling agent solution into the self-supporting film varies subtly according to the amount of the residual solvent in the self-supporting film, the drying temperature, the drying time, and the like. In other words, slight variations in the production process conditions cause variations in the surface properties and adhesiveness of the polyimide film obtained.

Furthermore, the degree of penetration of the silane coupling agent solution into the self-supporting film may vary with the surface state of the film, and may vary according to whether it is the side which was in contact with the support when producing the film (side B) or the opposite side which was not in contact with the support (side A). Thus adhesiveness may differ between side A and side B of the film.

There is very little variation in adhesiveness of the polyimide film having a relatively larger thickness, for example, having a thickness of about 40 μm. Such a problem of variation in adhesiveness may be apt to arise when the polyimide film is thinner.

An objective of the present invention is to provide a process for reliably producing a polyimide film with improved adhesiveness by minimizing the variation in adhesiveness of the polyimide film obtained. Another objective of the present invention is to provide a process for producing a polyimide film in which there is little difference in adhesiveness between the side which was in contact with the support when producing the self-supporting film of the polyimide precursor solution (side B) and the opposite side which was not in contact with the support (side A). A further objective of the present invention is to provide a copper-clad polyimide film with high peel strength, which comprises a polyimide film produced by this process.

The present invention relates to the following.

[1] A process for producing a polyimide film with a thickness of 7 μm to 30 μm, comprising steps of:

applying a solution containing a silane coupling agent, which has a hydrolyzable alkoxy group bound to an Si atom, to one side or both sides of a self-supporting film of a polyimide precursor solution; and

heating the self-supporting film with the silane coupling agent to effect imidization; wherein

the solution containing a silane coupling agent contains substantially no water, and

5% or more of the alkoxy group bound to an Si atom is hydrolyzed in the silane coupling agent in the solution.

[2] The process for producing a polyimide film as described in [1], wherein 5% to 95% of the alkoxy group bound to an Si atom is hydrolyzed in the silane coupling agent in the solution.

[3] The process for producing a polyimide film as described in [1], wherein the solution containing the silane coupling agent is prepared by adding water to the silane coupling agent or a solution of the silane coupling agent in an organic solvent to hydrolyze the alkoxy group bound to an Si atom, and adding, if necessary, an organic solvent to the resulting solution; and the amount of water added is within a range of 5 to 100 mol % relative to the total amount of the alkoxy group.

[4] The process for producing a polyimide film as described in [1], wherein the silane coupling agent comprises at least one selected from the group consisting of aminosilane coupling agents, epoxysilane coupling agents, and mercaptosilane coupling agents.

[5] The process for producing a polyimide film as described in [1], wherein the solution containing the silane coupling agent further contains an acid catalyst.

[6] A polyimide film produced by the process as described in [1].

[7] A copper-clad polyimide film having a copper layer laminated on the surface of the polyimide film as described in [6], wherein the surface of the polyimide film is the side to which a solution containing a silane coupling agent is applied in producing the polyimide film.

[8] The copper-clad polyimide film as described in [7], wherein the copper layer is formed on the polyimide film by adhering a copper foil with an adhesive.

[9] The copper-clad polyimide film as described in [7], wherein the copper layer is formed on the polyimide film by sputtering or vapor deposition.

[10] The copper-clad polyimide film as described in [8], wherein the polyimide film has a thickness of 7 μm to 30 μm; and the copper-clad polyimide film has a 90° peel strength of 0.7 N/mm or higher.

[11] The copper-clad polyimide film as described in [9], wherein the polyimide film has a thickness of 7 μm to 30 μm; and the copper-clad polyimide film has a 90° peel strength of 0.7 N/mm or higher.

Herein, 90° peel strength of a copper-clad polyimide film is determined from the 90° peeling test conducted at a pulling speed of 50 mm/min.

According to the present invention, for the purpose of improving adhesiveness of a polyimide film, a solution containing a silane coupling agent, in which 5% or more, preferably 5% to 95% of the alkoxy group bound to an Si atom is hydrolyzed to be a silanol group, is applied to one side or both sides of a self-supporting film of a polyimide precursor solution, and then the self-supporting film is heated to effect imidization. The silane coupling agent solution is prepared by adding water to the silane coupling agent or a solution of the silane coupling agent in an organic solvent to hydrolyze 5% or more of the alkoxy group bound to an Si atom, and, if necessary, adding an organic solvent to the resulting solution. The amount of water added is the minimum amount required for the hydrolysis of the alkoxy group so that the solution contains substantially no water when it is applied to the surface of the self-supporting film after hydrolysis.

Even when applied to a thin polyimide film with a thickness of 7 μm to 30 μm, further of 8 μm to 25 μm, particularly of about 10 μm, for example, by applying the above solution of the silane coupling agent to a self-supporting film of a polyimide precursor solution, a compound derived from the silane coupling agent may be reliably left in the polyimide film after heating to the amount corresponding to the applied silane coupling agent, for example, 90% or more of a theoretical residual ratio, without being influenced by subtle variations in the production process conditions. Accordingly, the effect of improving adhesiveness by the silane coupling agent can be reliably achieved. Furthermore, in contrast to the conventional process, whether it is the side which was in contact with the support when producing the self-supporting film of the polyimide precursor solution (side B) or the opposite side which was not in contact with the support (side A), a compound derived from the silane coupling agent may be reliably left in the polyimide film after heating to the amount corresponding to the applied silane coupling agent. Accordingly, there is little or no difference in adhesiveness between side A and side B of the polyimide film obtained.

Thus, according to the present invention, the variation in adhesiveness of the polyimide film obtained may be minimized, and therefore a polyimide film with improved adhesiveness as desired may be reliably produced. Furthermore, the present invention can provide a polyimide film in which there is little difference in adhesiveness between the side which was in contact with the support when producing the self-supporting film of the polyimide precursor solution (side B) and the opposite side which was not in contact with the support (side A).

### DETAILED DESCRIPTION OF THE INVENTION

According to the present invention, a solution containing a silane coupling agent, in which 5% or more of the alkoxy group bound to an Si atom is hydrolyzed, and containing substantially no water, is applied to one side or both sides of a self-supporting film of a polyimide precursor solution, and then the self-supporting film is heated to effect imidization, thereby forming a polyimide film.

A self-supporting film of a polyimide precursor solution may be prepared by flow-casting a solution of a polyimide precursor in an organic solvent to give a polyimide on a support, after adding an imidization catalyst, an organic phosphorous compound and/or an inorganic fine particle to the solution, if necessary, and then heating it sufficiently to make it self-supporting, which means a stage before a common curing process.

A preferable polyimide precursor may be prepared from an aromatic tetracarboxylic dianhydride and an aromatic diamine.

Among them, preferred is a polyimide precursor prepared from 3,3′,4,4′-biphenyltetracarboxylic dianhydride (hereinafter, sometimes abbreviated as “BPDA”), p-phenylenediamine (hereinafter, sometimes abbreviated as “PPD”) and optionally 4,4′-diaminodiphenyl ether (hereinafter, sometimes abbreviated as “DADE”). In this case, a ratio of PPD/DADE (molar ratio) is preferably 100/0 to 85/15.

And also, preferred is a polyimide precursor prepared from pyromellitic dianhydride (hereinafter, sometimes abbreviated as “PMDA”), or an aromatic tetracarboxylic dianhydride consisting of 3,3′,4,4′-biphenyltetracarboxylic dianhydride and pyromellitic dianhydride, and an aromatic diamine such as benzene diamine and biphenyldiamine. The aromatic diamine may be preferably p-phenylenediamine, an aromatic diamine in which a ratio of PPD/DADE is 90/10 to 10/90, or tolidine (ortho- and meta-types). In this case, a ratio of BPDA/PMDA is preferably 0/100 to 90/10.

In addition, preferred is a polyimide precursor prepared from pyromellitic dianhydride, p-phenylenediamine and 4,4′-diaminodiphenyl ether. In this case, a ratio of DADE/PPD is preferably 90/10 to 10/90.

A polyimide precursor can be synthesized by random-polymerizing or block-polymerizing substantially equimolar mixture of an aromatic tetracarboxylic dianhydride and an aromatic diamine in an organic solvent. Alternatively, two or more polyimide precursors in which either of these two components is excessive may be prepared, and subsequently, these polyimide precursor solutions may be combined and then mixed under reaction conditions. The polyimide precursor solution thus obtained may be used without any treatment, or may be used after removing or adding a solvent, if necessary, to prepare a self-supporting film.

Examples of an organic solvent for the polyimide precursor solution include N-methyl-2-pyrrolidone, N,N-dimethylformamide, N,N-dimethylacetamide and N,N-diethylacetamide. These organic solvents may be used alone or in combination of two or more.

The polyimide precursor solution may contain an imidization catalyst, an organic phosphorous-containing compound, an inorganic fine particle, and the like, if necessary.

Examples of the imidization catalyst include substituted or unsubstituted nitrogen-containing heterocyclic compounds, N-oxide compounds of the nitrogen-containing heterocyclic compounds, substituted or unsubstituted amino acid compounds, hydroxyl-containing aromatic hydrocarbon compounds, and aromatic heterocyclic compounds. Particularly suitable examples of the imidization catalyst used are lower-alkylimidazoles such as 1,2-dimethylimidazole, N-methylimidazole, N-benzyl-2-methylimidazole, 2-methylimidazole, 2-ethyl-4-imidazole and 5-methylbenzimidazole; benzimidazoles such as N-benzyl-2-methylimidazole; and substituted pyridines such as isoquinoline, 3,5-dimethylpyridine, 3,4-dimethylpyridine, 2,5-dimethylpyridine, 2,4-dimethylpyridine and 4-n-propylpyridine. The amount of the imidization catalyst used is preferably about 0.01 to 2 equivalents, particularly preferably about 0.02 to 1 equivalents relative to the amount of an amide acid unit in a polyamide acid. The use of the imidization catalyst is preferable because the polyimide film obtained has the improved properties, particularly extension and edge-cracking resistance.

Examples of the organic phosphorous-containing compound include phosphates such as monocaproyl phosphate, monooctyl phosphate, monolauryl phosphate, monomyristyl phosphate, monocetyl phosphate, monostearyl phosphate, triethyleneglycol monotridecyl ether monophosphate, tetraethyleneglycol monolauryl ether monophosphate, diethyleneglycol monostearyl ether monophosphate, dicaproyl phosphate, dioctyl phosphate, dicapryl phosphate, dilauryl phosphate, dimyristyl phosphate, dicetyl phosphate, distearyl phosphate, tetraethyleneglycol mononeopentyl ether diphosphate, triethyleneglycol monotridecyl ether diphosphate, tetraethyleneglycol monolauryl ether diphosphate, and diethyleneglycol monostearyl ether diphosphate; and amine salts of these phosphates. Examples of the amine include ammonia, monomethylamine, monoethylamine, monopropylamine, monobutylamine, dimethylamine, diethylamine, dipropylamine, dibutylamine, trimethylamine, triethylamine, tripropylamine, tributylamine, monoethanolamine, diethanolamine and triethanolamine.

Examples of the inorganic fine particle include particulate inorganic oxide powders such as titanium dioxide powder, silicon dioxide (silica) powder, magnesium oxide powder, aluminum oxide (alumina) powder and zinc oxide powder; particulate inorganic nitride powders such as silicon nitride powder and titanium nitride powder; inorganic carbide powders such as silicon carbide powder; and particulate inorganic salt powders such as calcium carbonate powder, calcium sulfate powder and barium sulfate powder. These inorganic fine particles may be used in combination of two or more. These inorganic fine particles can be homogeneously dispersed using the known means.

A self-supporting film of a polyimide precursor solution is prepared by flow-casting and applying the above-mentioned solution of a polyimide precursor in an organic solvent, or a polyimide precursor solution composition which is prepared by adding an imidization catalyst, an organic phosphorous-containing compound, an inorganic fine particle, and the like to the above solution, on a support, and then heating it to the extent that the film becomes self-supporting, which means a stage before a common curing process, for example, to the extent that the film can be peeled from the support; specifically, heating it at 100 to 180° C. for about 2 to 60 min. The content of the polyimide precursor in the polyimide precursor solution may be preferably about 10 to 30% by weight. The polyimide precursor solution may preferably have a polymer concentration of about 8 to 25% by weight. The support used may be a stainless substrate or a stainless belt, for example.

In the present invention, a silane coupling agent solution should be substantially uniformly, preferably uniformly and evenly, applied to one side or both sides of a peeled self-supporting film. Thus, the self-supporting film should be a film to one side or both sides of which a silane coupling agent solution can be applied substantially uniformly, preferably uniformly and evenly, and therefore, the heating conditions such as a heating temperature and a heating time should be appropriately selected to give such a film. For preparing such a film, it is necessary to control a solvent contained in the self-supporting film and imidization of the polyimide precursor.

It is preferable that a weight loss on heating is within a range of 20 to 40% by weight, and it is further preferable that a weight loss on heating is within a range of 20 to 40% by weight and an imidization rate is within a range of 8 to 40%, by reason that the self-supporting film obtained has sufficient mechanical properties, a silane coupling agent solution is evenly applied to the surface of the self-supporting film more easily, and no foaming, flaws, crazes, cracks and fissures are observed in the polyimide film obtained after imidizing.

The weight loss on heating of a self-supporting film as described above is calculated by the following equation from the weight before drying (W1) and the weight after drying (W2) of the film to be measured which is dried at 420° C. for 20 min.

Weight loss on heating (% by weight)={(W1−W2)/W1}×100

The imidization rate of a self-supporting film as described above can be determined in accordance with the procedure described in Japanese Laid-open Patent Publication No. 1997-316199, using a Karl Fischer moisture meter. For example, the imidization rate can be calculated based on the ratio of the vibration band peak area measured with IR spectrometer (ATR) between the film and a fully-cured product. The vibration band peak utilized in the procedure may include a symmetric stretching vibration band of an imide carbonyl group and a skeletal stretching vibration band of a benzene ring.

According to the present invention, a solution containing a silane coupling agent in which 5% or more of the alkoxy group bound to an Si atom is hydrolyzed, and containing substantially no water, is applied to one side or both sides of the self-supporting film thus obtained. The alkoxy-group hydrolysis rate (the proportion of the hydrolyzed alkoxy group) is preferably 5% to 95%, more preferably 10% to 70%, further preferably 15% to 60%, particularly preferably 30 to 60%. When attempting to obtain a solution containing a silane coupling agent with an alkoxy-group hydrolysis rate of 100%, the solution obtained is apt to contain unreacted water. For this reason, the alkoxy-group hydrolysis rate is preferably 95% or less.

The applied solution (application solution) can be prepared by adding water in an amount required for the hydrolysis of the alkoxy group to a silane coupling agent or a solution of a silane coupling agent in an organic solvent, to hydrolyze 5% or more of the alkoxy group bound to an Si atom; and then, if necessary, adding an organic solvent to the resulting solution. A hydroxysilane and a corresponding alcohol are formed by the hydrolysis of the alkoxy group.

Examples of the silane coupling agent used in the present invention may include, but not limited to, at least one selected from the group consisting of aminosilane coupling agents, epoxysilane coupling agents, and mercaptosilane coupling agents.

Preferable examples of the silane coupling agent include epoxysilane coupling agents such as γ-glycidoxypropyltrimethoxysilane, γ-glycidoxypropylmethyldiethoxysilane and β-(3,4-epoxycyclohexyl)ethyltrimethoxysilane; aminosilane coupling agents such as N-β-(aminoethyl)-γ-aminopropyltrimethoxysilane, N-β-(aminoethyl)-γ-aminopropylmethyldimethoxysilane, N-phenyl-γ-aminopropyltrimethoxysilane, N-β-(aminoethyl)-γ-aminopropyltriethoxysilane, N-(aminocarbonyl)-γ-aminopropyltriethoxysilane and N-[β-(phenylamino)-ethyl]-γ-aminopropyltriethoxysilane; and mercaptosilane coupling agents such as γ-mercaptopropyltrimethoxysilane, γ-mercaptopropyltriethoxysilane, γ-mercaptopropylmethyldimethoxysilane and γ-mercaptopropylmethyldiethoxysilane. Furthermore, a silane coupling agent having a methoxy group as an alkoxy group is preferable, because it is easily hydrolyzed. A particularly preferable coupling agent may be N-phenyl-γ-aminopropyltrimethoxysilane or γ-mercaptopropyltrimethoxysilane.

Examples of the organic solvent for the silane coupling agent solution may include those listed as the organic solvent for the polyimide precursor solution (the solvent contained in the self-supporting film).

The preferable organic solvent is a solvent compatible with the polyimide precursor solution, and is the same as the organic solvent for the polyimide precursor solution. The organic solvent may be a mixture of two or more compounds.

The amount of water added for hydrolysis is within a range of 5 to 100 mol %, preferably 5 to 95 mol %, more preferably 10 to 70 mol %, further preferably 15 to 60 mol %, particularly preferably 30 to 60 mol % relative to the total amount of the alkoxy group in the silane coupling agent. When the amount of water added is less than 5 mol % relative to the total amount of the alkoxy group, the sufficient effect may not be obtained. On the other hand, when the amount of water added is more than 100 mol %, the application solution contains unreacted water, and the surface tension of the application solution may be so high that a self-supporting film repels the solution, and/or an imidization reaction of a polyamic acid may be inhibited, leading to deterioration in the properties of the polyimide film obtained. The amount of water added is preferably 30 to 60 mol %, particularly preferably about 40 to 50 mol % relative to the total amount of the alkoxy group.

For accelerating a hydrolysis reaction, an acid catalyst may be added to the solution. There are no particular restrictions to the acid catalyst used in the present invention, so long as it is a weak acid. The examples may include acidic constituents, e.g. organic acids including carboxylic acids such as acetic acid, oxalic acid, tetracarboxylic acids and tricarboxylic acids. The amount of the acid catalyst added is preferably about 0.01 to 1 mol % relative to the amount of water.

Although the hydrolysis reaction of the alkoxy group in the silane coupling agent may be conducted in a solution containing the same concentration of the silane coupling agent as the application solution, owing to low concentration of the silane coupling agent, it may require the relatively long reaction time. Therefore, it is preferable that the hydrolysis reaction is conducted using a solution containing a silane coupling agent at 10 to 100% by weight, preferably 15 to 50% by weight as a starting reaction solution; and after the reaction, an organic solvent is added to the resulting solution, thereby adjusting the concentration of the silane coupling agent, to give a application solution. The hydrolysis reaction may be conducted at a reaction temperature of 40 to 100° C., preferably 50 to 70° C. for about 1 to 10 hours.

The concentration of the silane coupling agent in the application solution may be preferably 0.1 to 10% by weight, particularly preferably 0.5 to 5% by weight in terms of the concentration before hydrolysis. When the concentration of the silane coupling agent is less than 0.1% by weight, the sufficient effect may not be obtained. On the other hand, when the concentration of the silane coupling agent is too high, a modified layer derived from the silane coupling agent may be deposited on the surface of the film, and undesired coloring may appear in the polyimide film obtained.

In the present invention, the solution of a silane coupling agent, which is applied to the self-supporting film, contains substantially no water. When the application solution contains a large amount of water, a problem may arise during the application of the solution, and the properties of the polyimide film obtained may be deteriorated.

A solution of a coupling agent in an organic solvent preferably has a rotational viscosity (a solution viscosity measured with a rotation viscometer at a measurement temperature of 25° C.) of 0.5 to 50,000 centipoise.

Furthermore, a surfactant may be added to the solution containing the silane coupling agent so as to prevent repelling or grazing of the solution during application. Examples of the surfactant include silicon surfactants, fluorine surfactants, and hydrocarbon surfactants. A particularly preferable surfactant may be volatile at high temperature. Another additive component may be added to the solution, if necessary.

The application solution may preferably contain an acid catalyst. By using the application solution containing an acid catalyst, a polyimide film obtained may have further improved adhesiveness.

The application amount of the solution containing a silane coupling agent to be hydrolyzed may be appropriately determined, and is preferably 1 to 50 g/m², more preferably 2 to 30 g/m², particularly preferably 3 to 20 g/m² for both the side of the self-supporting film which was in contact with the support, and the opposite side. The application amount of the silane coupling agent solution to one side may be the same as, or different from the application amount of the silane coupling agent solution to the other side.

The solution containing a silane coupling agent to be hydrolyzed can be applied by any known method; for example, by gravure coating, spin coating, silk screen process, dip coating, spray coating, bar coating, knife coating, roll coating, blade coating, and die coating.

According to the present invention, the self-supporting film on which a silane coupling agent solution is applied is then heated to give a polyimide film.

The preferable heat treatment may be a process where polymer imidization and solvent evaporation/removal are gradually conducted at about 100 to 400° C. for about 0.05 to 5 hours, particularly 0.1 to 3 hours as the first step. This heat treatment is particularly preferably conducted stepwise, that is, the first heat treatment at a relatively lower temperature of about 100 to 170° C. for about 0.5 to 30 min, then the second heat treatment at 170 to 220° C. for about 0.5 to 30 min, and then the third heat treatment at a high temperature of 220 to 400° C. for about 0.5 to 30 min. If necessary, the fourth high-temperature heat treatment at 400 to 550° C. may be conducted. In continuous heat treatment at 250° C. or higher, it is preferable that at least both edges of a long solidified film in the direction perpendicular to the direction of the length are fixed with a pintenter, a clip or a frame, for example, while heating. When producing a thin polyimide film, the heat treatment may be conducted for a relatively short time.

Although there are no particular restrictions to the thickness of the polyimide film obtained according to the present invention, the more remarkable effect may be obtained when the present invention is applied to the production of a polyimide film with a thickness of preferably 7 μm to 30 μm, more preferably 8 μm to 25 μm, further preferably 9 μm to 20 μm, particularly preferably 10 μm to 18 μm.

A polyimide film obtained according to the present invention may have a Si surface atomic concentration (amount of Si atom in the surface of the polyimide film) of 0.0025 to 0.025 mol/m², preferably 0.005 to 0.02 mol/m². Furthermore, according to the present invention, a compound derived from a silane coupling agent may be left in the polyimide film in an amount of 90% or more of a theoretical residual ratio (a residual ratio when no silane coupling agent in the solution is vaporized).

A polyimide film obtained according to the present invention has improved adhesiveness, sputtering properties, and vapor deposition properties. Therefore, a metal foil such as a copper foil can be attached with an adhesive onto the side to which a silane coupling agent is applied, to give a metal-clad polyimide film such as a copper-clad polyimide film having excellent adhesiveness and sufficiently high peel strength. Alternatively, a metal layer such as a copper layer can be formed by sputtering or vapor deposition on the side to which a silane coupling agent is applied, to give a metal-clad polyimide film such as a copper-clad polyimide film having excellent adhesiveness and sufficiently high peel strength. A metal layer can be laminated onto a polyimide film by a known method.

According to the present invention, there may be provided, for example, a copper-clad polyimide film having a 90° peel strength of 0.5 N/mm or higher, particularly 0.6 N/mm or higher, further 0.7 N/mm or higher, and a thickness of the polyimide film comprised therein of 7 μm to 30 μm, more preferably 8 μm to 25 μm, further preferably 9 μm to 20 μm, particularly preferably 10 μm to 18 μm. A thickness of a copper layer may be appropriately determined depending on an intended application, and is preferably about 1 μm to 20 μm.

### EXAMPLES

The present invention will be more specifically described with reference to the following Examples. However, the present invention is not limited to these Examples.

### Reference Example 1

To N-phenyl-γ-aminopropyltrimethoxysilane were added 50 mol % of water relative to the total amount of the alkoxy group in the silane coupling agent, and an acid catalyst, and the resulting mixture was reacted at 60° C. for 5 hours to hydrolyze 50% of the alkoxy group bound to an Si atom. Then, N,N-dimethylacetamide was added to the partially hydrolyzed silane coupling agent solution thus obtained, to form a silane coupling agent solution with a concentration of 20% by weight in terms of the concentration before the hydrolysis.

After heating the solution containing the acid catalyst at 450° C. for 3 min, 4.4% by weight of SiO₂ remained (a theoretical residual ratio of SiO₂:4.7% by weight).

In contrast, when a non-hydrolyzed silane coupling agent solution with a concentration of 20% by weight, which was prepared without partial hydrolysis of N-phenyl-γ-aminopropyltrimethoxysilane as a silane coupling agent, was heated at 450° C. for 3 min as described above, a small amount of SiO₂ remained. When heating the solution at 200° C. for 3 min, a small amount of SiO₂ remained.

### Example 1

Into a polymerization tank were placed a given amount of N,N-dimethylacetamide, p-phenylenediamine, and 3,3′,4,4′-biphenyltetracarboxylic dianhydride in this order. And then, the resulting mixture was polymerized at 30° C. for 10 hours, to give a polyimide precursor solution having a polymer inherent viscosity (measurement temperature: 30° C., concentration: 0.5 g/100 mL solvent, solvent: N,N-dimethylacetamide) of 1.60 and a polymer concentration of 18% by weight. To the polyimide precursor solution was added 2.4 parts by weight of 1,2-dimethylimidazole relative to 100 parts by weight of the polyimide precursor, and the resulting mixture was homogeneously mixed to give a polyimide precursor solution composition. The polyimide precursor solution composition had a rotational viscosity of 3,000 poise.

The polyimide precursor solution composition thus obtained was applied on a glass plate as a support, to form a thin film on the support. The thin film was heated at 130° C. for 3 min, and then peeled off from the support to give a self-supporting film.

On side A or side B of this self-supporting film was applied the 3.5 wt % partially-hydrolyzed silane coupling agent solution with an alkoxy-group hydrolysis rate of 50% prepared as described in Reference Example 1, i.e. a solution containing a silane coupling agent (N-phenyl-γ-aminopropyltrimethoxysilane) in which 50% of the alkoxy group is hydrolyzed, N,N-dimethylacetamide as a solvent, and an acid catalyst, with a silane coupling agent concentration of 3.5 wt % in terms of the concentration before the hydrolysis, at the application amount of 5 g/m² with a bar coater. And then, the film was dried on a hot plate. Subsequently, the dried film was fed into a continuous heating oven while fixing both edges of the film in the width direction, and the film was imidized by heating under the conditions of the highest heating temperature in the oven of about 440° C., to prepare a polyimide film having an average thickness of 25 μm.

The polyimide film thus obtained, an adhesive sheet (Du Pont, Pyralux LF) and a rolled copper foil (Nikko Materials Co., Ltd., BHY-13H-T, thickness: 18 μm) were laminated, and the laminate was hot-pressed at 180° C. for 1 min and then heated at 180° C. for 1 hour, to prepare a copper-clad polyimide film. As the measurement result, the copper-clad polyimide film having the copper foil on side A had a 90° peel strength of 1.1 N/mm, and the copper-clad polyimide film having the copper foil on side B had a 90° peel strength of 1.0 N/mm.

### Reference Example 2

A copper-clad polyimide film was prepared in the same way as Example 1, except that N-phenyl-γ-aminopropyltrimethoxysilane was used as a silane coupling agent without partially hydrolyzing. As the measurement result, the copper-clad polyimide film having the copper foil on side A had a 90° peel strength of 0.9 N/mm, and the copper-clad polyimide film having the copper foil on side B had a 90° peel strength of 0.7 N/mm.

### Reference Example 3

A copper-clad polyimide film was prepared in the same way as Example 1, except that a 3.5 wt % solution of a non-hydrolyzed silane coupling agent (N-phenyl-γ-aminopropyltrimethoxysilane) in ethanol was used as a solution applied to the self-supporting film. As the measurement result, the copper-clad polyimide film having the copper foil on side A had a 90° peel strength of 0.9 N/mm, and the copper-clad polyimide film having the copper foil on side B had a 90° peel strength of 0.6 N/mm.

### Example 2

A copper-clad polyimide film was prepared in the same way as Example 1, except that the average thickness of the polyimide film obtained was 15 μm. As the measurement result, the copper-clad polyimide film having the copper foil on side A had a 90° peel strength of 0.9 N/mm, and the copper-clad polyimide film having the copper foil on side B had a 90° peel strength of 0.9 N/mm.

### Reference Example 4

A copper-clad polyimide film was prepared in the same way as Reference Example 2, except that the average thickness of the polyimide film obtained was 15 μm. As the measurement result, the copper-clad polyimide film having the copper foil on side A had a 90° peel strength of 0.7 N/mm, and the copper-clad polyimide film having the copper foil on side B had a 90° peel strength of 0.6 N/mm.

As described above, according to the present invention, the variation in adhesiveness of the polyimide film obtained may be minimized, and therefore a polyimide film with improved adhesiveness may be reliably produced, especially when producing a thin polyimide film. Furthermore, according to the present invention, there can be provided a polyimide film in which there is little difference in adhesiveness between the side which was in contact with the support when producing the self-supporting film of the polyimide precursor solution (side B) and the opposite side which was not in contact with the support (side A).

What is claimed is:

1. A process for producing a polyimide film with a thickness of 7 μm to 30 μm, comprising steps of:
applying a solution containing a silane coupling agent, which has a hydrolyzable alkoxy group bound to an Si atom, to one side or both sides of a self-supporting film of a polyimide precursor solution; and
heating the self-supporting film with the silane coupling agent to effect imidization; wherein
the solution containing a silane coupling agent contains substantially no water, and
5% or more of the alkoxy group bound to an Si atom is hydrolyzed in the silane coupling agent in the solution.

2. The process for producing a polyimide film as claimed in claim 1, wherein 5% to 95% of the alkoxy group bound to an Si atom is hydrolyzed in the silane coupling agent in the solution.

3. The process for producing a polyimide film as claimed in claim 1, wherein the solution containing the silane coupling agent is prepared by adding water to the silane coupling agent or a solution of the silane coupling agent in an organic solvent to hydrolyze the alkoxy group bound to an Si atom, and adding, if necessary, an organic solvent to the resulting solution; and the amount of water added is within a range of 5 to 100 mol % relative to the total amount of the alkoxy group.

4. The process for producing a polyimide film as claimed in claim 1, wherein the silane coupling agent comprises at least one selected from the group consisting of aminosilane coupling agents, epoxysilane coupling agents, and mercaptosilane coupling agents.

5. The process for producing a polyimide film as claimed in claim 1, wherein the solution containing the silane coupling agent further contains an acid catalyst.

6. A polyimide film produced by the process as claimed in claim 1.

7. A copper-clad polyimide film having a copper layer laminated on the surface of the polyimide film as claimed in claim 6, wherein the surface of the polyimide film is the side to which a solution containing a silane coupling agent is applied in producing the polyimide film.

8. The copper-clad polyimide film as claimed in claim 7, wherein the copper layer is formed on the polyimide film by adhering a copper foil with an adhesive.

9. The copper-clad polyimide film as claimed in claim 7, wherein the copper layer is formed on the polyimide film by sputtering or vapor deposition.

10. The copper-clad polyimide film as claimed in claim 8, wherein the polyimide film has a thickness of 7 μm to 30 μm; and the copper-clad polyimide film has a 90° peel strength of 0.7 N/mm or higher.

11. The copper-clad polyimide film as claimed in claim 9, wherein the polyimide film has a thickness of 7 μm to 30 μm; and the copper-clad polyimide film has a 90° peel strength of 0.7 N/mm or higher.
